(19) United States
(12) Patent Application Publication
(10) Pub. No.: US 2026/0093222 A1
(43) Pub. Date: Apr. 2, 2026

(54) AI CAPABLE UPS AND CONTROLLER

(71) Applicant: M.C. Dean IP, LLC, Tysons, VA (US)

(72) Inventor: George Arthur NAVARRO, Raleigh, NC (US)

(73) Assignee: M.C. Dean IP, LLC, Tysons, VA (US)

(21) Appl. No.: 19/345,866

(22) Filed: Sep. 30, 2025

Related U.S. Application Data
(60) Provisional application No. 63/702,059, filed on Oct. 1, 2024.
(60) Provisional application No. 63/854,304, filed on Jul. 30, 2025.

(51) Int. Cl. G05B 19/042

(52) U.S. Cl. CPC G05B 19/042; G05B 2219/2639

(57) ABSTRACT

An artificial intelligence (AI) capable uninterruptible power supply (UPS) controller is provided for a building that receives grid power from one or more sources to power electrical equipment, and which has a backup power supply that includes a battery back-up and an on-site electrical generator. The controller includes an AI circuit configured to receive learning data into an inference model such as the amount of real-time power received from the grid source, the real-time power load necessary to operate the electrical equipment, state of charge of the battery back-up, frequency and length of grid failures, and the necessity of uninterrupted operation of the electrical equipment. The AI circuit, in response to machine learning outputs of the inference model, actuates the backup power supply to maintain uninterrupted operation of the electrical equipment when necessary while minimizing the operational and maintenance costs of the UPS.

### CROSS-REFERENCE TO RELATED APPLICATIONS

This application claims benefit of priority to U.S. Provisional Application No. 63/702,059 filed Oct. 1, 2024 and U.S. Provisional Application No. 63/854,304 filed Jul. 30, 2025, the entire contents of which are incorporated herein by reference.

### FIELD

This invention generally relates to uninterruptible power supply (UPS) controllers and is specifically concerned with UPS controllers having artificial intelligence (AI) capabilities.

### BACKGROUND

Some buildings such as data centers and hospitals require very stable power. In data centers, power interruptions can cause a catastrophic loss of data from the banks of servers, data storage, and other electronic equipment. In medical facilities, power interruptions can shut down in-use life-support equipment resulting in the death of a patient. As grid power is not 100% reliable and can have poor power quality, such buildings derive this stability by having a backup power source comprising an uninterruptible UPS with a battery back-up and an on-site electrical generator. Both the UPS and a building transfer switch constantly monitor the grid power input to the data center for a grid failure. In the event that a grid failure is detected, the transfer switch initiates a transfer from grid power to backup power, prompting the UPS to switch to the battery back-up to initially meet the critical load until the generator ramps to full voltage and speed. Once this is accomplished, the UPS connects its input to the output of the on-site generator so that long duration backup power may be provided if needed.

Conventional UPS controllers continuously monitor all grid sources of power and, upon detection of a grid source failure lasting a predetermined amount of time, actuate the UPS to switch power over to the back-up power source. Such grid source failures include not only the detection of a complete or partial loss of power from a grid source (i.e., a blackout or a brownout) but also an unacceptable degradation of utility power in terms of voltage, frequency or phase angle. Under such a failure, the transfer time should be of sufficiently short duration so that the functioning of the data center servers continues seamlessly. Accordingly, conventional UPS controllers in data centers are programmed with algorithms that define a minimum acceptable threshold of voltage, frequency, and phase angle that must be received from each grid source to meet the load required by the data center, and an amount of time that must pass before the UPS is actuated, which is typically the amount of time that constitutes the likelihood of a total loss of power from the grid.

### SUMMARY

The algorithms and the decision parameters that a conventional UPS uses are typically invariant and non-adaptive. Consequently, such conventional UPS controls will make the same decisions regardless of the specific environmental factors affecting the data center or hospital operational profile, the specific types of failures of the grid sources (e.g., blackout or brownout of a grid source), or type of medical equipment being powered (such as in-use life support machinery) or the type of data that the data center is processing (e.g., real-time financial transactions vs. scientific computations that can be started over without significant negative consequences).

These shortcomings are exacerbated by the ever-increasing computational loads applied to data centers. These larger loads are a result of cloud computing and ever more reliance upon AI-based machine learning and model inference processing of the type used in smartphones, social media, and search engines. Such chronic high loads strain the datacenter power capacity and induce small or very short-term voltage disturbances resulting in more frequent switchovers to the backup power source, which in turn increases the maintenance cost of the battery backup and on-site generator.

What is needed is a UPS controller capable of making more finely nuanced decisions in switching over to the backup power source. Such a UPS controller should be able to recognize not only what kind of failure is happening (e.g., partial vs. complete failure of a grid source; failure of a particular phase of a grid source) but should also be able to compute a probability of whether the failure will continue past a critical time limit wherein data will be lost. Such a probability may be based on historical patterns of such failures. For example, is the failure occurring under high load conditions of the grid when short period brownouts are most likely to occur? Is the failure occurring under severe weather conditions when power failures are likely to last long past a critical time limit? The UPS controller should also continuously monitor the type of medical equipment being powered or type of data being processed so that it can continuously adjust the amount of time by which a switchover to the backup power source must occur. For example, this switchover time would be less than a one 60 Hz cycle in the case of real time financial transactions, but could be seconds or even minutes long in the case of scientific calculations that could tolerate a much longer power interruption without significant negative consequences. Ideally, such a UPS controller would be able to anticipate load and source requirements and generate risk profiles based on learnings of past operational profiles, and self-optimize its behavior (e.g., speed of transfer and topology) depending on the amount of energy stored in the batteries of the backup power source. It would also be desirable if the UPS controller could anticipate potential UPS failures based on the frequency of use and the service history of the UPS power electronics, battery back-up and on-site generator, and generate or orchestrate customized maintenance procedures regarding, e.g., the preventive maintenance of UPS power electronics, batteries and the diesel engines or other alternative-fueled power sources powering the back-up generators to avoid potential failures that lead to the loss of power to critical servers and information technology systems in the datacenter. Finally, the UPS controller should at all times operate at or above a constant, predetermined failure rate despite any modifications in its decision making due to its learning from the aforementioned data.

To these ends, the invention is an AI capable UPS controller for a building that receives grid power from one or more sources to power electrical equipment, and which has a backup power supply that includes a battery back-up and an on-site electrical generator for powering the electrical equipment in the event of failure of the grid power. The controller comprises at least one AI circuit configured to receive learning data into an inference model in the form of the amount of real-time power received from the grid source, the real-time power load necessary to operate the electrical equipment, state of charge of the battery back-up, the power load profile, real-time weather conditions, peak grid load conditions, and frequency and length of blackouts, brownouts, and near failures due to degraded power, and the necessity of uninterrupted operation of the electrical equipment. In response to the machine learning output of the inference model, the AI circuit may select a time delay by which to start the electrical generator after the battery back-up has been actuated that is based on an expected length of a detected grid failure, and then proceed to actuate the battery back-up and to start the electrical generator after the selected delay time has expired. The selected delay time may be longer than that of the delay time afforded by a conventionally-operated UPS in a case where the inference model predicts, on the basis of the inputted learning data, that the probability is high that the duration of the grid failure will be short enough for the battery-back up to supply all of the power needed before the battery charge drops below a critical level. Alternatively, in response to an output of the inference model indicating that the uninterrupted operation of the electrical equipment is unnecessary, the AI circuit may refrain from actuating the backup power at all. Finally, the AI circuit may actuate only the battery back-up component of the backup power in response to an output of the inference model indicating that, even though there is no necessity to operate the electrical equipment continuously, the grid failure is likely to end before the battery back-up is drained below a predetermined critical amount. All three modes of operation save unnecessary wear associated with the start-up of the fossil fuel engine that powers the electrical generator.

As the inference model of the AI capable UPS controller is constantly being modified to change the probabilities associated with its output neural layer, there is a danger that the reliability of the controller will fall below an acceptable failure rate. To prevent this, the AI circuit is programmed to calculate the effect on reliability of any change made to the inference model before such a change is implemented. If the proposed modification to the inference model reduces the reliability of the AI capable UPS controller to a level which is not acceptable, the AI circuit will not implement it.

In the case where the UPS is a dual-conversion type UPS, the inference model of the AI circuit receives learning data in the form of the real-time voltage, frequency, and phase angle of the grid power, and acceptable ranges of voltage, frequency and phase angle of the grid power, and provides a machine-learning output that operates the controller to service the critical load either directly by grid power or through the dual-conversion capability of the UPS.

The AI capable UPS controller may control switchgear capable of shutting power off from selected pieces of the electrical equipment. In such a case, the inference model of the AI circuit will, in the event that there is insufficient power to service all pieces of electrical equipment, direct the controller to maintain power to those pieces of electrical equipment whose uninterrupted operation is necessary while selectively shutting down those pieces of electrical equipment whose uninterrupted operation is unnecessary.

The inference model of the AI circuit may receive further learning data in the form of an electrical load that the battery-back up is capable of, and a history of loads applied to the battery back-up over time, and provide a machine learning output that makes a recommendation as to whether or not the load capacity of the battery back-up should be increased or decreased.

The inference model of the AI circuit may receive further learning data in the form of the number of times during a determined maintenance period that the UPS controller ordered a switchover to the battery back-up and to the electrical generator, a length of time that each switchover lasted, the last time the on-site electrical generator was serviced, the amount of reserve fossil fuel available for the fossil fuel engine that drives the electrical generator, the age of individual batteries in the battery back-up, and a time required to fully recharge the battery back-up after switching back to grid power, and provide a machine learning output that makes a recommendation with respect to maintenance operations of the battery back-up and the on-site electrical generator.

### BRIEF DESCRIPTION OF THE DRAWINGS

FIG. 1 is a schematic diagram of the AI capable UPS controller of the invention;

FIG. 2A is a machine learning diagram of how the AI circuit, shown in FIG. 1, builds an inference model of optimal switching over to the backup sources of power;

FIG. 2B is a schematic diagram of how the inference model of the AI circuit continuously modifies the operation of the AI capable UPS controller;

FIG. 3 is a flow chart illustrating the steps taken by the AI capable UPS controller to ensure that the controller always protects the critical load with at least a 90% reliability.

FIG. 4 is a machine learning flow chart of how the AI circuit, shown in FIG. 1, builds an inference model of optimizing the operation of the backup power resources, and

FIG. 5 is a machine learning flow chart of how the AI circuit, shown in FIG. 1, builds an inference model to reduce service costs and reduce the mean time for repairs of the UPS.

### DETAILED DESCRIPTION OF A PREFERRED EMBODIMENT

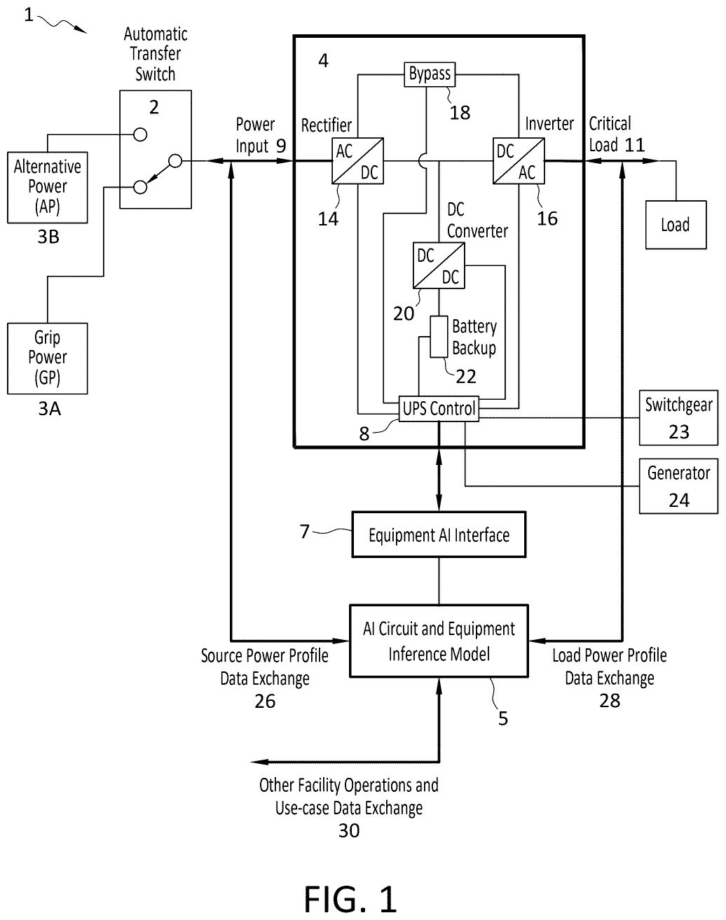

With reference to FIG. 1, the AI capable UPS 1 in this example includes a transfer switch 2 that switches the load from grid power 3A to alternative or back-up power 3B, and a dual conversion-type UPS 4 in combination with an AI circuit and the equipment inference model that it generates, which from this point forward is referred to as the AI circuit 5. The output of the AI circuit 5 is connected to a control circuit 8 of the UPS 4 via an equipment AI interface 7 as shown. The control circuit 8 is a digital processor having a memory of a type well known in the prior art and will not be described in detail. The control circuit 8 controls the actuation of back-up power 3B (which includes a battery back-up 22 and an electrical generator 24 as described later) as well as switchgear 23. The power input 9 of the UPS 4 receives power from one or more power grid sources 3A. The power output of the UPS 4 services the critical load 11 applied to the UPS 4 from the electrical equipment of the building the UPS serves, which would include servers and other information technology (IT) equipment for a data center, and life-support equipment and other medical devices of a hospital.

The dual conversion-type UPS 4 converts the three phase AC input power received from the grid power 3A first into DC and then back to an AC output. To this end, the UPS 4 includes a rectifier 14 and an inverter 16 that are serially connected. This dual conversion capability allows the UPS 4 to continuously provide clean AC power whose voltage and frequency varies less than ±1% despite relatively large voltage and frequency variations on the order of ±10% in the grid power 3A due, e.g., to power surges and brown outs during heavy load conditions. Such sinusoidally stabilized voltage helps to prevent malfunctions and errors from occurring in the processing output of the servers and other electronic equipment of the data center. A bypass power circuit 18 that includes a switch is connected between the input of the rectifier 14 and the output of the inverter 16 to provide the option of running the data center directly off the grid power source 3A. The bypass power circuit 18 may be switched on in a case where the grid reliably supplies clean, surge-free power within ±5% of the expected voltage and frequency. The bypass power circuit 18 is also used during maintenance operations of the UPS 4. UPS 4 further includes a DC-to-DC battery converter 20 having an input connected to the DC output of the rectifier 14, and an output connected to an input of the battery back-up 22. Battery converter 20 converts the UPS DC link to battery voltage levels or the battery voltage to the DC link voltage consistent with the charge or discharge requirements to support the critical output load and target battery state-of-charge (SOC).

When the power input 9 from the grid fails to meet the critical load 11 of the data center, the UPS control circuit 8, in accordance with the machine learning provided by the AI circuit and equipment inference model 5, decides when to activate the battery back-up 22 and the electrical generator 24 (which together form the alternative power 3B) and other UPS operational modes that support the output critical load 11, such as the switchgear 23 that routes power to specific racks of servers in the case of a data center, and specific medical equipment in the case of a hospital.

The AI circuit 5 (which may be one or more AI integrated circuits and computational software) continuously receives data from three sources, including a source power profile data exchange circuit 26 connected to the input 9, a load power profile data exchange circuit 28 connected to the critical load 11 that indicates variations in the critical load 11 over time, and a facility operations and use-case data exchange circuit 30 that will be described in more detail hereinafter. AI circuit 5 enters this data into an inference model to control the operation and operational modes of the UPS control circuit 8. The output of the inference model of the AI circuit 5 is connected to an input of the UPS control circuit 8 via equipment AI interface 7 as shown.

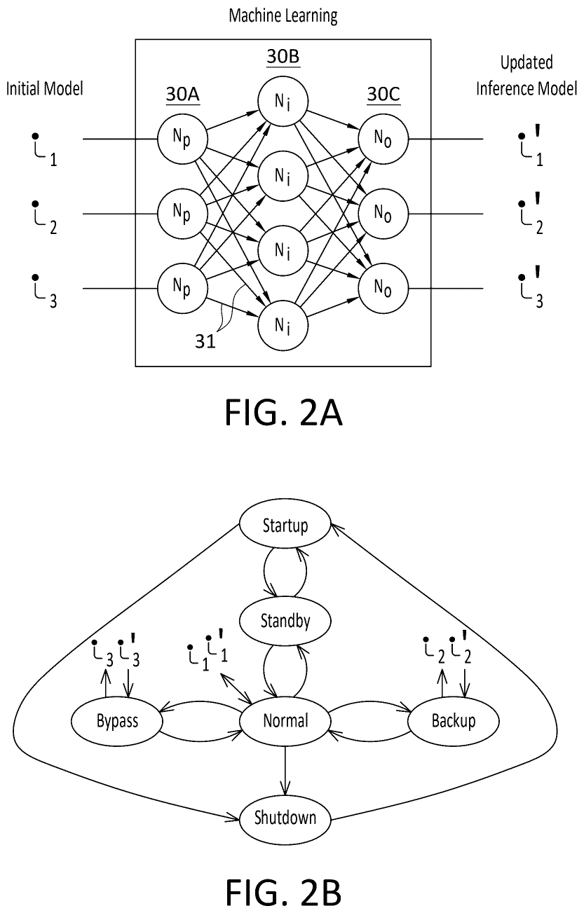

FIGS. 2A and 2B are schematic diagrams illustrating how the inference model of the AI circuit 5 continuously evolves in response to inputted data. The AI circuit 5 provides nodes Np, Ni, and No, respectively, in an input layer, 30A, intermediate (or hidden) layers 30B, of which only one layer is shown for simplicity, and an output layer 30C arranged in a feed-forward neural network. Each node Np of the input layer 30A corresponds to one of the types of learning data ingested by the AI circuit (e.g., an amount of real-time power received from the grid source, a real-time power load necessary to operate the electrical equipment, state of charge of the battery back-up, and a history of frequency and length of grid failures, etc.). Each node Np of the input layer 30A is connected to one of the nodes Ni of the intermediate layer 30B by pathways 31 assigned specific weights in an arbitrary manner. The nodes of the plurality of intermediate layers 30B are interconnected in the same manner via specifically weighted pathways 31 as between the input layer 30A and the first of the intermediate layers 30B. Each of the nodes Ni of the intermediate layers are assigned bias weights, again in an arbitrary manner. The nodes Ni in the last of the intermediate layers 30B are interconnected to the nodes No of the output layer 30C likewise via arbitrarily weighted pathways 31. Each of the nodes No of the output layer 30C corresponds to a probability of a specific UPS control circuit 8 operation (e.g., actuation of the on-site electrical generator 24 of the UPS 4 after actuating the battery back-up 22 depending on an expected length of a grid failure, implementation of the inference model depending upon whether a preselected amount of reliability is maintained, etc.) While a recurrent neural network is used in the AI circuit 5 of this example of the invention, other types of neural networks (e.g. a feed forward neural network) can also be used.

When the AI circuit 5 is initially started, a first set of learning data is entered into the nodes Np of the input layer 30A and this data is processed through the pathways 31 and nodes Ni in the intermediate layers 30B via a non-linear loss function. The non-linear loss function computes probabilities from the weights of the pathways 31 and bias weights of the nodes Ni in the intermediate layers 30B and assigns these probabilities to the nodes in the output layer 30C. This initial processing is known as forward propagation. These initial probability values are compared to the actual probabilities indicated by the data. The weights of the pathways 31 and bias weights of the nodes Ni in the intermediate layers 30B are changed—via backward propagation—in ways that will bring the computed probabilities closer to the actual probabilities. The inference model of the AI circuit 5 is thus created and continuously refined by repeating forward propagation with new data, followed by a repetition of backward propagation until the probabilities assigned to the nodes in the output layer converge to match the actual probabilities indicated by the data. FIG. 2B represents the effect of the resulting inference model of the AI circuit 5 on the operation of the UPS control circuit 8. Here, normal operation i₁, back-up power operation i₂, and bypass operation i₃ are continuously evolving into updated normal operation i_{1′}, updated back-up power operation i_{2′}, and updated bypass operation i_{3′}. For example, a transition from the operating modes i₁, i₂, and i₃ to i_{1′}, i_{2′}, and i_{3′} may occur as a result of an influx of data indicating that back-to-back brownouts are likely to occur, thereby causing the inference model of the AI circuit to continuously utilize the dual-conversion capability of the UPS 4 even when there are some periods of time between brownouts when the voltage, frequency and phase angle of the grid power is within acceptable limits.

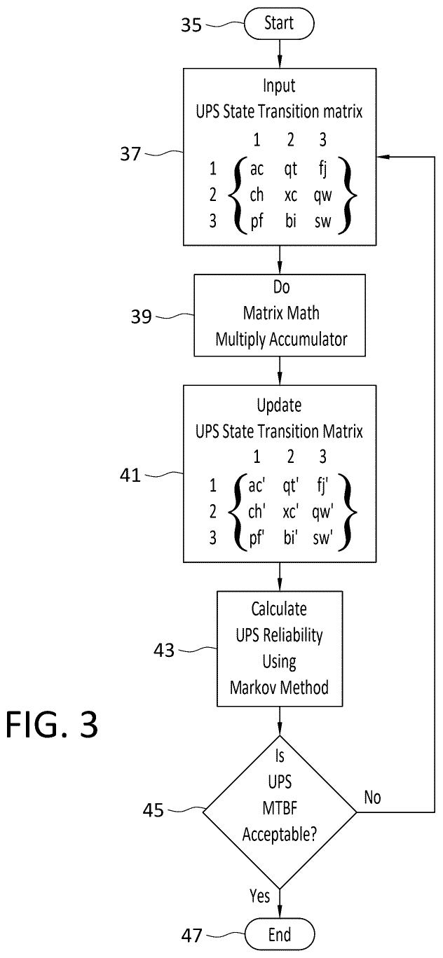

FIG. 3 is a flow chart illustrating how the AI circuit 5 maintains a pre-selected level of reliability despite constant changes to new modes of operation such as, for example, the new operational modes i_{1′}, i_{2′}, and i_{3′} indicated in FIG. 2B. After start-up at block 35, block 39 proceeds to calculate a new mode of operation from a present UPS state transition matrix indicated in block 37 to an updated UPS state transition matrix indicated in block 41, without actually implementing the new mode of operation. The AI circuit 5 is programmed to constantly look for ways to improve its operation, and the computations made at block 39 might arise in response to an influx of new data indicating, for example, that the mission of the AI capable UPS 1 could be achieved with fewer batteries in the battery back-up 22 or fewer startups of the diesel engine driving the electrical generator. At step 43, the AI circuit 5 computes what the reliability of the AI capable UPS 1 would be if the simulated new mode of operation were implemented by the inference model. Such reliability may be expressed as a mean time between failures, or MTBF. In practice, this number is indicative of at least a 90% reliability. In step 45, the AI circuit inquires whether the MTBF of the updated UPS state transition matrix indicated in block 41 is acceptable. If not, the updated UPS state transition matrix 41 is not implemented, and the operation of the UPS state transition matrix indicated in block 37 is maintained. However, if the MTBF of the updated UPS state transition matrix is acceptable, then it is adopted and implemented by the inference model.

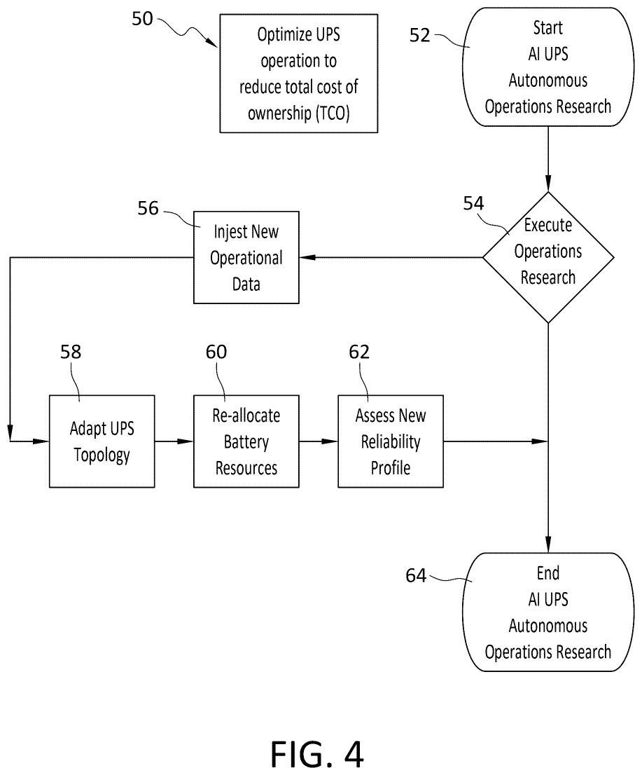

FIG. 4 is a flow chart 50 illustrating how the AI circuit 5 ingests learning data and builds an inference model via machine learning to minimize operational expenses of the AI capable UPS 1. Immediately after start-up at step 52, step 54 commences the execution of the operations research program. The AI proceeds to step 56 and starts to continually ingest new operational learning data from the power profile input data circuit 26 (i.e., the voltage and frequency and phase angle of each of the three phases of the grid current entering the UPS at power input 9 over time), and the load profile data exchange circuit 28 of the critical load 11 (i.e., planned load due to AI datacenter machine learning sessions which can present considerable changes in load ramping and load level) that is applied to the AI capable UPS 1 by the servers and other electrical equipment of the data center. Learning data is also ingested by the AI circuit 5 from the facility operations and use-case data exchange circuit 30, including, but not limited to, the type of data that the data center is processing (e.g., financial and resiliency considerations associated with datacenter operations like real-time financial transactions, scientific computations like datacenter machine learning that can be started over without significant negative consequences), the date and time of day that the learning data was ingested, the ambient temperature, the temperature within the data center, the load on the data center HVAC, and the state-of-charge of the batteries in the battery back-up 22. Other data ingested from the circuit 30 includes historical data of grid failures due to blackouts, brownouts, and near failures due to degraded power having voltage or frequency or phase angle that varies from, for example, the nominal levels for 480 V, 60 Hz in either voltage or frequency greater than a target percentage and the associated action taken by the UPS 1, e.g., any adaptations be they conventional switchovers that included only the battery back-up 22, and the back-up generator. Advanced adaptations include changes in UPS or system topology that satisfies the optimal solutions that come from the AI UPS operations research and machine learning. Also ingested is the length of time of each adaption which can manifest itself in the form of time duration taken to effect the adaptation, and the timestamp (date and time) of the switchover decision. Finally, operational data on grid brown-outs and black-outs due to high load conditions (e.g., air-conditioning equipment on hot days) or storm conditions, and local weather forecasts can also be ingested from circuit 30. The sum total of all of this incoming data may be referred to as “incoming data that matters”, or IDTM.

The AI circuit 5 builds an inference model from the learning data ingested at step 56 that controls the response of the UPS control circuit 8 when the AI detects a grid failure. Such grid failures can take several forms, including a complete blackout of grid power, a brownout wherein a reduction of voltage renders the grid power insufficient to meet the critical load 11, or a degradation of either or both of the voltage and frequency of at least one of the three phases of the three-phase power input. The response of the UPS control circuit 8 may also take several forms for each category of grid failure. In the case of a grid blackout, the UPS control circuit 8 may decide not to switchover to any back-up power supply in a case where the data being processed by the data center are scientific computations that can be computed at a later time. Alternatively, the control circuit 8 may decide to switchover to the battery back-up 22 but delay switchover to the back-up generator until the batteries are near depletion. This alternative minimizes the wear of the high-maintenance diesel engine or other alternative-fueled power sources that power the back-up generator at the expense of some small probability that the nearly depleted batteries will not charge quickly enough to service the critical load should another grid power failure occur. In other words, in the process of weighing this alternative, the inference model of the AI circuit 5 considers the historical data of grid failures due to blackouts, brownouts, and near failures to determine the likelihood of a subsequent failure occurring before the battery back-up has an opportunity to be fully recharged. Finally, the UPS control circuit 8 may more promptly switchover to the back-up generator in a case where real-time financial transactions are being processed by the data center, thus increasing the reliability of the UPS function at the expense of increased maintenance cost of the diesel-powered generator and energy sustainability goals (for example, carbon footprint).

With further reference to FIG. 4, the AI circuit 5 proceeds to step 58 and considers whether current grid conditions justify a change in the power routing topology of the UPS 1. One previously mentioned example of topology change would hinge on the reliability of the grid in providing surge-free three-phase 480V, 60 Hz cycle current within +5%. If the inference model concluded that the present reliability of the grid was high in this regard, it would command the UPS control circuit 8 to close the switch in the bypass conductor 18 to route the grid power directly to the critical load 11, thus increasing efficiency by avoiding the 3-4% loss in efficiency when the grid power is routed through the rectifier 14 and inverter 16 for dual conversion. The AI inference model can also reconfigure the switchgear switches 23 through the UPS control circuit 8 under extreme or emergency conditions (e.g., an extended blackout occurring during high grid load conditions, a failure of the back-up generator) where there is not enough available back-up power to operate all of the equipment in the data center or hospital. Under such conditions, the inference model of the AI circuit 5 can direct the UPS control circuit 8 to shut down electrical equipment that does not require continuous operation at the time of the grid failure. In the case of a data center, those specific banks of servers and other electronic equipment that are not conducting critical, real-time processing might be shut down so that the servers and other equipment that are conducting critical real-time processing can continue to do so. In the case of a hospital, the UPS control circuit may direct the switches of the switchgear 23 to continue powering in-use life support equipment while shutting down other medical equipment.

Conversely, in the case of a brown-out or the detection of degraded power, the inference model of the AI circuit 5 may first re-route the grid power 9 from the bypass conductor 18 (assuming it is being used) to the serially-connected rectifier 14 and inverter 16 such that the voltage of the grid power is tightly regulated to 480 V and 60 Hz. If the resulting output of the inverter 16 is insufficient to service the critical load 11, then the AI circuit 5 might command the UPS control circuit 8 to switchover to the battery back-up 22 such that the critical load 11 is met by the combination of the dual-converted power from the grid and power from the battery back-up 22. If the brownout is long enough to begin to significantly deplete the power stored in the battery back-up 22, the AI inference model may decide to actuate the diesel-powered or other alternative-fueled powered back-up generator either later or sooner, taking into consideration the same factors discussed with the second and third blackout responses. The above-described topological adaptations are just a few of many types and descriptions, one can say that the personality of the UPS, which comprises situational awareness and value-centered prioritization inferred by the model, changes on a regular basis during a lifecycle of continuous learning and targeted adaptation.

Next, the AI circuit 5 proceeds to step 60 and considers whether or not the resources available in the battery back-up 22 should be changed or re-allocated. Some background is necessary for this capability to be appreciated. When the UPS systems presently in service were designed and installed, the power storage capacity of the battery back-ups were designed to handle a worst-case scenario where the grid power suffered a maximum amount of blackout, brownouts, and degraded power episodes. Accordingly, the vast majority of battery back-ups in UPS systems presently in use have a substantial over capacity in the amount of power they can store. The recharging, maintenance, and periodic replacement of the batteries in such back-ups often results in substantial unnecessary maintenance costs. Accordingly, the inference model of the AI circuit 5 calculates an optimum power capacity of the battery back-up that will result in a near 100% reliability based on the actual history of blackout, brownouts, and degraded power episodes considered along with the history of the responses to such grid failures. If this optimum power capacity is less than the actual power capacity of the battery back-up, then the AI circuit 5 makes a recommendation as to how many fewer batteries are needed to achieve optimum power capacity.

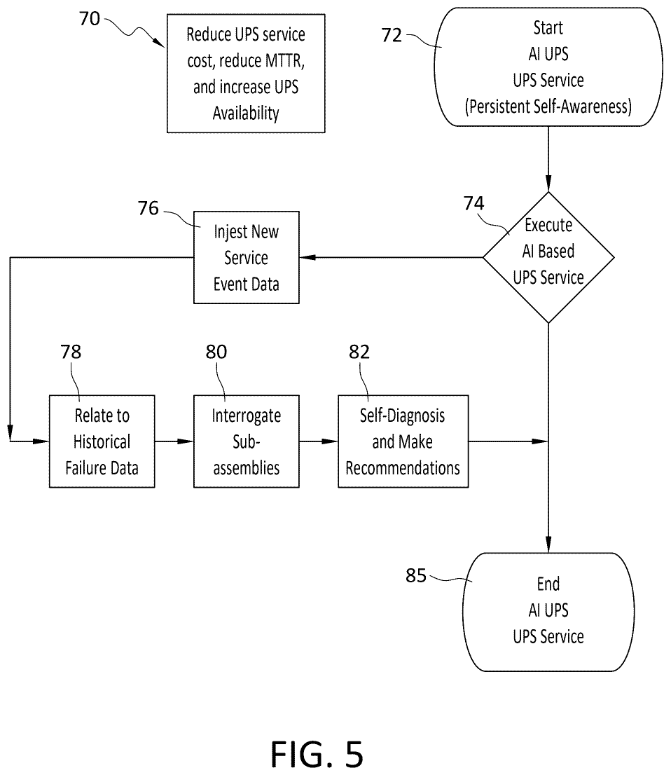

Finally, the AI circuit 5 proceeds to step 62 and assesses the over-all reliability of the AI capable UPS 1 taking into account the age and number of re-chargings of the batteries in the battery back-up, the age and condition of the diesel engine or other alternative-fueled power source that drives the back-up generator, and the age and condition of the switchgear. Step 62 can also consider the data and conclusions reached with respect to the maintenance flowchart 70 illustrated in FIG. 5, which will be discussed directly.

FIG. 5 is a flow chart 70 illustrating how the AI circuit 5 continuously self-diagnosis itself and makes maintenance recommendations to reduce service costs, reduce the mean time for repairs, and increase the availability and reliability of the UPS 1. Upon start-up in step 72, the program commences execution at step 74 and proceeds to step 76 to ingest service event data. Such service event data may include the number of times during a determined maintenance period that the AI circuit 5 has ordered a switchover to the battery back-up 22 and to the diesel-powered or other alternative-fueled powered generator back-up, the length of time that each battery switchover lasted and the length of time that each back-up generator switchover lasted, the last time the back-up generator was serviced, the amount of reserve fuel available for the diesel engine, the age of the batteries in the battery back-up 22, and the time required to fully recharge the batteries of the back-up 22 after switching back to grid power.

The AI circuit 5 then proceeds to step 78 to ingest and consider any and all historical failure data of the UPS 1, and then to step 80 to interrogate all subassemblies of the UPS 1. On the basis of all of the learning data received in steps 76, 78, and 80, it then proceeds to self-diagnose and make maintenance recommendations as indicated in step 82.

In operation, the machine learning capabilities of the AI capable UPS 1 builds over time an ever more sophisticated inference model from the continuous streams of data entering it from the power profile input 26, the critical load profile 28, and the other input data input 30. Consequently, the inference model generated by the AI circuit 5 can learn to identify particular patterns of grid power failures and develop specifically tailored responses that minimize unnecessary wear on the UPS 1. For example, the inference model might identify a particular grid power failure as a momentary brown-out very likely to end before the back-up generator of the UPS 1 could start up and begin to produce enough power to meet the critical load 11. In such a case, the UPS control circuit 8 would transmit control signals to the UPS switchgear that would switch the critical load 11 of the data center to the battery back-up 22 without starting up the diesel engine or other alternative-fueled power source powering the back-up generator. In another example, even when the inference model determined that a particular grid failure is very likely to last longer than the critical time before data was lost, it could decide not to actuate a switchover at all if it determined that a loss of data was not consequential, as during either scientific calculations or training sessions for the AI chips to develop the inference model.

In addition to providing the UPS 1 with more nuanced responses to various types of grid failures, the AI capable UPS control circuit 8 is able to upgrade brownfield installations with virtually no additional expenses beyond the cost of the AI hardware and installation of the AI Model Interface. This advantage follows from the UPS control circuit's 8 ability to learn and to build its inference model in a manner that does not risk the critical output load using a scheduler that prescribes the lowest risk learning periods. Essentially, the AI capable UPS control circuit 8 can build the inference model and at the same time protect the critical output load at least as well as a conventional UPS controller immediately after its installation.

Although the invention has been described in detail with particular reference to a preferred embodiment, it will be understood that variations and modifications can be affected within the spirit and scope of the invention. All such variations and modifications are within the scope of this invention, which is limited only by the terms of the appended claims and their equivalents.

1. An artificial intelligence (AI) capable uninterruptible power supply (UPS) controller for a building that receives grid power from one or more sources to power electrical equipment, and which has a backup power supply that includes a battery back-up and an on-site electrical generator for powering the electrical equipment in the event of failure of the grid power, comprising:
at least one AI circuit that is configured to:
receive learning data into an inference model in the form of an amount of real-time power received from the grid source, a real-time power load necessary to operate the electrical equipment, state of charge of the battery back-up, and a history of frequency and length of grid failures, and
responsive to a machine learning output of the inference model regarding an expected length of a grid failure, select a time to actuate the electrical generator after actuating the battery back-up, and then actuate the on-site electrical generator at the selected time.

2. The AI capable UPS controller defined in claim 1, wherein the at least one AI circuit is further configured to determine in advance an expected UPS reliability associated with the inference model, and to forego the implementation of the inference model if the associated UPS reliability falls below a preselected reliability.

3. The AI capable UPS controller defined in claim 1, wherein the at least one AI circuit is configured to receive learning data into the inference model in the form of a necessity of uninterrupted operation of the electrical equipment, and, responsive to an output of the inference model, either actuate the backup power supply, fail to actuate backup power supply, or actuate only the battery back-up of the backup power supply.

4. The AI capable UPS controller defined in claim 1, wherein the UPS includes dual-conversion circuitry, and wherein the at least one AI circuit is configured to receive learning data into the inference model in the form of the real-time voltage and frequency of the grid power, and acceptable ranges of voltage and frequency of the grid power, and, responsive to an output of the inference model, service the critical load directly by grid power or through the dual-conversion circuitry of the UPS.

5. The AI capable UPS controller defined in claim 1, wherein the controller is configured to control switchgear capable of shutting power off from selected pieces of the electrical equipment, and wherein the at least one AI circuit receives learning data into the inference model as to whether there is insufficient power to service all pieces of electrical equipment, and, responsive to an output of the inference model based on a detection of insufficient power, operate the switchgear to maintain power to those pieces of electrical equipment whose uninterrupted operation is necessary while selectively shutting down pieces of electrical equipment whose uninterrupted operation is unnecessary.

6. The AI capable UPS controller defined in claim 1, wherein the at least one AI circuit is further configured to receive learning data into the inference model in the form of an electrical load that the battery-back up is capable of, and a history of electrical loads applied to the battery back-up over time, and, responsive to an output of the inference model, make a recommendation as to whether or not the load capacity of the battery back-up should be increased or decreased.

7. The AI capable UPS controller defined in claim 1, wherein the at least one AI circuit is further configured to receive learning data in the form of a number of times during a determined maintenance period that the UPS controller ordered a switchover to the battery back-up and to the electrical generator, and a length of time that each switchover lasted, and, responsive to an output of the inference model, make a recommendation with respect to a maintenance operation of the battery back-up and to the on-site electrical generator.

8. The AI capable UPS controller defined in claim 1, wherein the on-site electrical generator is powered by a fossil fuel engine, wherein the at least one AI circuit is further configured to receive learning data in the form of a last time the on-site electrical generator was serviced, an amount of reserve fossil fuel available for the fossil fuel engine, the age of individual batteries in the battery back-up, and a time required to fully recharge the battery back-up after switching back to grid power, and, responsive to an output of the inference model, make a recommendation with respect to maintenance operations of the battery back-up, the fossil fuel engine, and the on-site electrical generator.

9. The AI capable UPS controller defined in claim 1, wherein the at least one AI circuit is further configured to receive learning data in the form of historical failures of the battery back-up and on-site electrical generator, and, responsive to an output of the inference model, make a recommendation with respect to maintenance operations of the battery back-up and to the on-site electrical generator.

10. An artificial intelligence (AI) capable uninterruptible power supply (UPS) controller for a building that receives grid power from one or more sources to power electrical equipment, and which has a backup power supply that includes a battery back-up and an on-site electrical generator for powering the electrical equipment in the event of failure of the grid power, comprising:
at least one AI circuit that is configured to:
receive learning data into an inference model in the form of an amount of real-time power received from the grid source, a real-time power load necessary to operate the electrical equipment, a state of charge of the battery back-up, a history of frequency and length of grid failures, and a necessity of uninterrupted operation of the electrical equipment, and
responsive to a machine learning output of the inference model regarding an expected length of a grid failure and necessity of uninterrupted operation of the electrical equipment, either actuates the backup power supply after selecting a time to actuate the electrical generator, actuate the backup power supply, refrain from actuating the backup power supply, or actuate only the battery back-up of the backup power supply.

11. The AI capable UPS controller defined in claim 10, wherein the at least one AI circuit decides whether or not to implement the inference model depending upon whether a preselected reliability is maintained.

12. The AI capable UPS controller defined in claim 10, wherein the building is a data center, the electrical equipment is electronic computational equipment, and wherein the AI circuit receives learning data into the inference model as to the necessity of uninterrupted processing of real-time data by the electronic computational equipment.

13. The AI capable UPS controller defined in claim 12, wherein the real-time data includes real-time financial transactions that necessitate uninterrupted operation of the electronic computational equipment.

14. The AI capable UPS controller defined in claim 10, wherein the building is a medical facility, and the electrical equipment includes life-support equipment for which uninterrupted operation is necessary.

15. The AI capable UPS controller defined in claim 10, wherein the building includes an HVAC system, and wherein the at least one AI circuit receives learning data into the inference model in the form of a temperature of the building interior and an electrical load applied by the HVAC system.

16. An artificial intelligence (AI) capable uninterruptible power supply (UPS) controller for a building that receives grid power from one or more sources to power electrical equipment, and which has a backup power supply that includes a battery back-up and an on-site electrical generator for powering the electrical equipment in the event of failure of the grid power, comprising:
at least one AI circuit that is configured to:
receive learning data into an inference model in the form of an amount of real-time power received from a grid source, a real-time power load necessary to operate the electrical equipment, state of charge of the battery back-up, a power load profile, real-time weather conditions, peak grid load conditions, frequency and length of grid failures, a necessity of uninterrupted operation of the electrical equipment, a number of times during a determined maintenance period that the UPS controller ordered a switchover to the battery back-up and to the electrical generator, and a length of time that each switchover lasted, and
responsive to a machine learning output of the inference model, either actuate the backup power supply after selecting a time to actuate the electrical generator, refrain from actuating the backup power supply, or actuate only the battery back-up of the backup power supply and make a recommendation as to whether and when a maintenance operation should be conducted on the battery back-up and to the electrical generator.

17. The AI capable UPS controller defined in claim 16, wherein the at least one AI circuit decides whether or not to implement the inference model depending upon whether a preselected amount of reliability is maintained.

18. The AI capable UPS controller defined in claim 16, wherein the UPS includes dual-conversion circuitry, and wherein the at least one AI circuit is further configured to receive learning data into the inference model in the form of the real-time voltage and frequency of the grid power, and acceptable ranges of voltage and frequency of the grid power, and, responsive to an output of the inference model, switches the critical load directly to grid power or to an output of the dual-conversion circuitry.

19. The AI capable UPS controller defined in claim 16, wherein the controller controls switchgear capable of shutting power off of selected pieces of the electrical equipment, and, responsive to a machine learning output of the inference model regarding a detection insufficient power to service all pieces of electrical equipment, maintains power to those pieces of electrical equipment whose uninterrupted operation is necessary while selectively shutting down pieces of electrical equipment whose uninterrupted operation is unnecessary.

20. The AI capable UPS controller defined in claim 16, wherein the on-site electrical generator is powered by a fossil fuel engine, wherein the at least one AI circuit is further configured to receive learning data in the form of a last time the on-site electrical generator was serviced, an amount of reserve fossil fuel available for the fossil fuel engine, the age of individual batteries in the battery back-up, and a time required to fully recharge the battery back-up after switching back to grid power, and, responsive to an output of the inference model, make a recommendation as to whether and when a maintenance operation should be conducted on one of the electrical generator, the fossil fuel engine, and the battery back-up.
